(19) United States
(12) Patent Application Publication
(10) Pub. No.: US 2014/0313429 A1
(43) Pub. Date: Oct. 23, 2014

(54) PROJECTION LIQUID CRYSTAL DISPLAY DEVICE

(71) Applicant: Isao Takahashi, Tokyo (JP)

(72) Inventor: Isao Takahashi, Tokyo (JP)

(21) Appl. No.: 14/357,189

(22) PCT Filed: Dec. 20, 2011
(86) PCT No.: PCT/JP2011/079514

§ 371 Date: May 8, 2014

(51) Int. Cl. G02F 1/1335

(52) U.S. Cl. CPC G02F 1/133536
USPC 349/5

(57) ABSTRACT

A projection liquid crystal display device including: a liquid crystal panel that forms a projected image; a reflective inorganic polarizing plate placed on a light incident side of the liquid crystal panel; and a wire grid type absorptive inorganic polarizing plate placed on a light emission side of the liquid crystal panel, wherein the reflective inorganic polarizing plate is placed non-parallel with respect to the absorptive inorganic polarizing plate.

### TECHNICAL FIELD

The present invention relates to a projection liquid crystal display device that forms and projects an image on a liquid crystal panel using a light emitted from a light source.

### BACKGROUND ART

In a projection liquid crystal display device of a three plate type, each of liquid crystal panels corresponding to three colors: R (red), G (green), and B (blue), respectively has polarizing plates on both the light emission side and the light incident side. The polarizing plate includes an absorptive polarizing plate that absorbs an electromagnetic wave in a certain polarization direction to determine the polarization direction, and a reflective polarizing plate that causes total reflection according to an incident polarization direction to determine a polarization direction. The “liquid crystal panel” herein refers to a panel in which a liquid crystal is sealed between a pair of glass substrates which have a pixel electrode and an oriented film formed thereon.

On the light emission side of the liquid crystal panel, if the reflective polarizing plate is placed without interposing anything between the reflective polarizing plate and the liquid crystal panel, most of that lights that do not pass through the reflective polarizing plate from among lights that passed through the liquid crystal panel are reflected to the liquid crystal panel.

This provides an image without sufficient contrast. Thus, the reflective polarizing plate is not usually placed on the light emission side of the liquid crystal panel, instead, the absorptive polarizing plate is placed on the light emission side of the liquid crystal panel.

Also, in order to increase the long life of the projection liquid crystal display device described above, measures are taken to increase durability of the polarizing plate that is subjected to light and heat. For example, in the three plate type, if an organic polarization film is placed in an optical path of a blue light (B optical path), burning of the film (changing color to yellow) occurs. Thus, an inorganic polarizing plate made from a glass substrate has been increasingly used. In recent years, a wire grid type absorptive inorganic polarizing plate has been developed (for example, see the description of paragraph [0052] in Patent Literature 1 (JP2008-102416A)).

Comparing the absorptive inorganic polarizing plate with the reflective inorganic polarizing plate, the reflective inorganic polarizing plate is more inexpensive. Thus, manufacturers desire to use the reflective inorganic polarizing plate as a polarizing plate on the light incident side of the liquid crystal panel, and to use the absorptive inorganic polarizing plate as an analyzer on the light emission side of the liquid crystal panel.

However, the wire grid type absorptive inorganic polarizing plate generates a slight reflected light due to variations in performance of a light absorption wire layer provided on a surface (for example, see the description in paragraph [0007] in Patent Literature 2 (JP2010-79172A)). Also, attention has recently been focused on reducing the size of the projection display device of a three plate type. By decreasing the size of the device, it becomes more difficult for a parallel light to be incident on a liquid crystal panel and an optical component therearound, and the incident light tends to have various angles with respect to a light incident surface of the liquid crystal panel.

Thus, in the case where the reflective inorganic polarizing plate is provided on the light incident side of the liquid crystal panel, and where the absorptive inorganic polarizing plate is provided on the light emission side of the liquid crystal panel, placing the plates in parallel may generate stray light due to multiple reflection between a polarizer and an analyzer.

For example, as shown in FIG. 1, in the case where an image including a white window image at the center of a black image is displayed, a part of light 1 that constitutes a white image is reflected by absorptive inorganic polarizing plate 2 on a light emission side, passes through liquid crystal panel 3, is then reflected by reflective inorganic polarizing plate 4 on a light incident side, again passes through liquid crystal panel 3, and reaches absorptive inorganic polarizing plate 2. At this time, light 1 after having passed through polarizing plate 4 on the light incident side is actually not completely linearly polarized light. Light 1 includes a mixture of two components of S polarized light and P polarized light although either S polarized light or P polarized light accounts for a large part (in FIG. 1(a), the S polarized light is shown by solid lines and the P polarized light is shown by dotted lines). Besides, due to the reduction in size as described above, light that constitutes an image has various angles with respect to a light incident surface of liquid crystal panel 3. From these points, when light 1, immediately after passing through polarizing plate 4, is S polarized light, the light passes once through white display portion 3a of liquid crystal panel 3 and passes twice through black display portion 3b, while being reflected between polarizing plate 2 and polarizing plate 4, and consequently the light becomes stray light 5 of the P polarized light. On the other hand, when light 1 after passing through polarizing plate 4 is P polarized light, the light passes twice through white display portion 3a of liquid crystal panel 3 and passes once through black display portion 3b, and consequently the light becomes stray light 5 of P polarized light. Thus, portion g corresponding to stray light 5 appears at a boundary between black image 6 and white window image 7 therein. FIG. 1(b) shows brightness distribution of the light having passed through polarizing plate 2 after the light was reflected as shown in FIG. 1(a), and FIG. 1(c) is a plan view of a projected image formed by the light.

As for the stray light described above, placing the absorptive inorganic polarizing plate having low reflectivity as polarizing plate 4 on the light incident side of the liquid crystal panel reduces brightness of the stray light, which makes clear the boundary between the black image and the white window image therein. However, the absorptive inorganic polarizing plate is more expensive and also has lower light transmission than characteristics the reflective inorganic polarizing plate, which provides a dark projected image. Also, using an organic polarization film as polarizing plate 4 on the light incident side causes burning of the film as described above to reduce the life of the projection liquid crystal display device.

Patent Literature 3 (JP2011-107724A) discloses a configuration in which a wire grid type reflective inorganic polarizing plate is provided on a light incident side of a liquid crystal panel, an absorptive organic polarizing plate is provided on a light emission side of a liquid crystal panel, and the reflective inorganic polarizing plate on the light incident side is tilted with respect to an illumination optical axis. This is a technique such that tilting the wire grid type reflective inorganic polarizing plate with respect to the illumination optical axis substantially reduces a pitch of periodic microstructures that are provided on a surface of the reflective inorganic polarizing plate with respect to incident light in a direction along the illumination optical axis, thereby increasing polarization separation properties. Thus, the configuration disclosed in Patent Literature 3 is not the technique that addresses the problem to be solved by the present invention as described above. Specifically, in Patent Literature 3, the polarizing plate on the light emission side of the liquid crystal panel is the absorptive organic polarizing plate, and does not generate even a slight reflected light unlike the wire grid type absorptive inorganic polarizing plate. Thus, even if incident light on the liquid crystal panel takes on an angles with respect to an incident surface of the liquid crystal panel as the size of the projection liquid crystal display device decreases, multiple reflection and stray light are not caused between the polarizer and the analyzer. Further, since the organic polarizing plate is used on the light emission side of the liquid crystal panel, the life of the projection liquid crystal display device cannot be increased. Thus, the present invention described below is a technique that has a different problem to be solved and a different configuration from those of the invention that is described in Patent Literature 3.

### SUMMARY OF INVENTION

An example of an object of the present invention is to increase the life of a projection liquid crystal display device including an illumination optical system that irradiates a liquid crystal panel with a light at an angle with respect to an incident surface thereof to reduce the size of the device, and is also to increase brightness and definition of a projected image

One aspect of the present invention provides a projection liquid crystal display device, including: a liquid crystal panel that forms a projected image; an illumination optical system that irradiates the liquid crystal panel with a light at an angle with respect to a light incident surface thereof; a reflective inorganic polarizing plate placed on a light incident side of the liquid crystal panel; and an absorptive inorganic polarizing plate placed on a light emission side of the liquid crystal panel, wherein the reflective inorganic polarizing plate is placed non-parallel with respect to the absorptive inorganic polarizing plate.

### BRIEF DESCRIPTION OF DRAWINGS

FIG. 1 illustrates a principle of generation of stray light that is one of the problems to be solved by the present invention.

FIG. 2 is a schematic configuration diagram of a projection liquid crystal display device according to an exemplary embodiment.

FIG. 3 illustrates an advantage of the configuration in FIG. 2 eliminating the stray light.

FIG. 4 illustrates an example of a rotation mechanism of a polarizing plate placed on a light emission side of a liquid crystal panel in an exemplary embodiment.

### DESCRIPTION OF EMBODIMENT

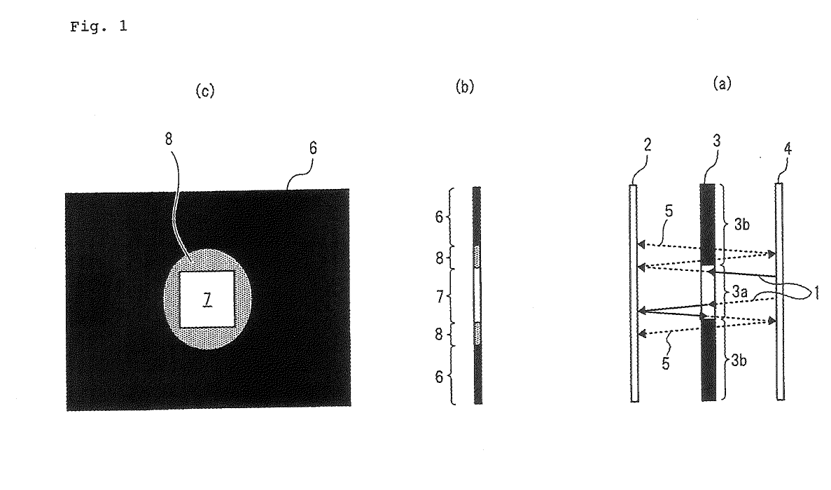

Now, an exemplary embodiment will be described with reference to the drawings. The same components as those shown in FIG. 1 are denoted by the same reference numerals.

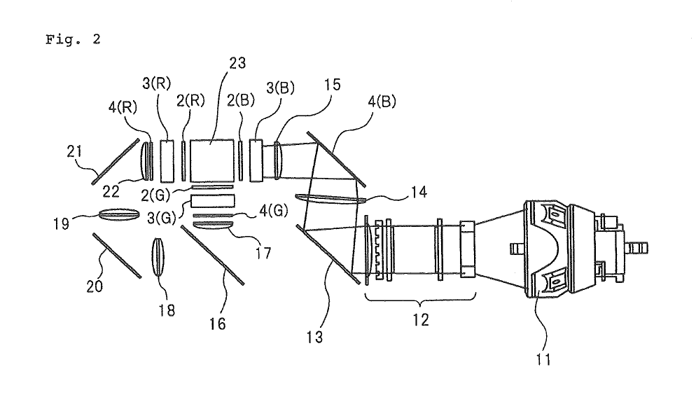

FIG. 2 is a plan view showing an optical system of a projection liquid crystal display device of a three plate type to which the present invention is applied.

A white light that is emitted from lamp unit 11 including a light source such as a metal halide lamp or a mercury lamp and a reflector is guided through integrator optical system 12 to first dichroic mirror 13.

Integrator optical system 12 averages uneven brightness in the white light emitted from lamp unit 11, and reduces the difference in the amount of light between the center and the periphery of a screen. Further, integrator optical system 12 includes a polarization conversion element, and converts and outputs the white light emitted from lamp unit 11 into a white light including a polarization component of either P polarized light or S polarized light that can be used in liquid crystal panel 3.

First dichroic mirror 13 reflects light in a blue wavelength band, and transmits lights in other wavelength bands. The light in the blue wavelength band reflected by first dichroic mirror 13 passes through condenser lens 14, is then reflected by reflective inorganic polarizing plate 4(B) and changed in optical path. Further, the light in the blue wavelength band passes through condenser lens 15, liquid crystal panel 3(B) in order to transmit blue light, and wire grid type absorptive inorganic polarizing plate 2(B) in this order.

In this blue optical path, a light transmission axis of reflective inorganic polarizing plate 4(B) is placed perpendicularly to the polarization direction of a light from an illumination optical system including lamp unit 11 and integrator optical system 12 so that the light from the illumination optical system can be fully reflected to liquid crystal panel 3(B) side by reflective inorganic polarizing plate 4(B). When liquid crystal panel 3(B) transmits the light in a predetermined polarization direction reflected by reflective inorganic polarizing plate 4(B), liquid crystal panel 3(B) modulates the light to light in a polarization direction perpendicular to the predetermined polarization direction based on an image signal. Wire grid type absorptive inorganic polarizing plate 2(B) has a light transmission axis set in a direction such as to transmit only the modulated polarized light.

On the other hand, the light having passed through first dichroic minor 13 (not shown) is guided to second dichroic mirror 16. Second dichroic mirror 16 reflects a light in a green wavelength band, and transmits light in a red wavelength band. The light in the green wavelength band that is reflected by second dichroic mirror 16 passes through condenser lens 17, reflective inorganic polarizing plate 4(G), liquid crystal panel 3(G) in order to transmit green light, and wire grid type absorptive inorganic polarizing plate 2(G) in this order.

In the green optical path, the light transmission axis of reflective inorganic polarizing plate 4(G) is placed to match the polarization direction of the light from the illumination optical system so that the light from the illumination optical system can be fully transmitted to liquid crystal panel 3(G) side by reflective inorganic polarizing plate 4(G). When liquid crystal panel 3(G) transmits light, that has passed through reflective inorganic polarizing plate 4(G), in a predetermined polarization direction, liquid crystal panel 3(B) modulates the light to a light in a polarization direction perpendicular to the predetermined polarization direction based on an image signal. Wire grid type absorptive inorganic polarizing plate 2(G) has a light transmission axis set in a direction so as to transmit only the modulated polarized light.

Further, the light in the red wavelength band (not shown) having passed through second dichroic mirror 16 passes through relay lenses 18, 19 and total reflection minors 20, 21, then passes through condenser lens 22, reflective inorganic polarizing plate 4(R), liquid crystal panel 3(R) in order to transmit red right, and wire grid type absorptive inorganic polarizing plate 2(R) in this order.

In the red optical path, a light transmission axis of reflective inorganic polarizing plate 4(R) is placed to match the polarization direction of the light from the illumination optical system so that the light from the illumination optical system can be fully transmitted to liquid crystal panel 3(R) side by reflective inorganic polarizing plate 4(R). When liquid crystal panel 3(R) transmits light, that has passed through reflective inorganic polarizing plate 4(R), in a predetermined polarization direction, liquid crystal panel 3(R) modulates the light to a light in a polarization direction perpendicular to the predetermined polarization direction based on an image signal. Wire grid type absorptive inorganic polarizing plate 2(R) has a light transmission axis set in a direction so as to transmit only the modulated polarized light.

As described above, the lights having passed through absorptive inorganic polarizing plates 2(B), 2(G), 2(R) in the optical paths of the respective colors (modulated lights of the liquid crystal panels) are synthesized by dichroic prism 23 to form a color image light. The color image light emitted from dichroic prism 23 is enlarged and projected on a screen or a white wall by a projection lens (not shown).

In the exemplary embodiment described above, to increase the long life of the projection liquid crystal display device, a polarizing plate of an inorganic material is used as the polarizing plate placed on the light incident side and the light emission side of the transmission liquid crystal panel. In particular, the blue light has higher intensity than the other red and green lights, and thus it is effective in terms of durability that the polarizing plate in the blue optical path is the inorganic polarizing plate. Of course, the projected image has increased brightness, and thus the inorganic polarizing plates are preferably also used as the polarizing plates in the green and red optical paths as in the exemplary embodiment described above.

Further, as the polarizing plate on the light emission side of the transmission liquid crystal panel, the absorptive inorganic polarizing plate is used to prevent light reflection to the liquid crystal panel, while the reflective inorganic polarizing plate is used as the polarizing plate on the light incident side of the liquid crystal panel to reduce cost of the device.

However, as described in Background Art, the wire grid type absorptive inorganic polarizing plate currently available in the market as the absorptive inorganic polarizing plate generates a slight amount of reflected light. Also, a reduction in size of the device prevents illumination light from the illumination optical system to the liquid crystal panel from being parallel light perpendicular to the light incident surface of the liquid crystal panel, and the illumination light tends to be light with an angle. Thus, in a configuration in which the reflective inorganic polarizing plate is provided on the light incident side of the liquid crystal panel and the wire grid type absorptive inorganic polarizing plate is provided on the light emission side of the liquid crystal panel, placing the inorganic polarizing plates parallel with respect to each other may generate stray light 5 as described with reference to FIG. 1.

Thus, in the present invention, reflective inorganic polarizing plate 4 is tilted with respect to an optical axis of an illumination light (hereinafter referred to as an illumination optical axis) to be incident on each liquid crystal panel from the illumination optical system including lamp unit 11 and integrator optical system 12, and placed non-parallel with respect to absorptive inorganic polarizing plate 2. Liquid crystal panel 3 is placed substantially parallel with respect to absorptive inorganic polarizing plate 2.

This measure is taken for the blue optical path in which the above-described problem is most likely to occur due to the increased life and the decreased size of the projection liquid crystal display device in the exemplary embodiment. Of course, in the case where the above-described problem is expected to occur in the green and red optical paths, reflective inorganic polarizing plate 4 in the optical paths may be tilted. The present invention may be applied to an absorptive inorganic polarizing plate other than that of a wire grid type as long as it generates even a slight amount of reflected light.

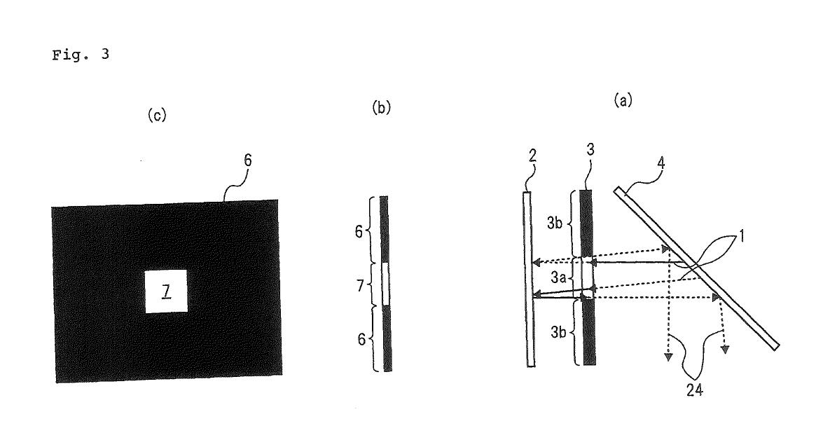

The principle of tilting of reflective inorganic polarizing plate 4 eliminating stray light 5 will be described below. FIG. 3(a) shows an irradiation light in the configuration with tilted reflective inorganic polarizing plate 4, FIG. 3(b) shows brightness distribution of the light having passed through polarizing plate 2 after the light was reflected as shown in FIG. 3(a), and FIG. 3(c) is a plan view of a projected image formed by the light.

As shown in FIG. 3(a), the light reflected by polarizing plate 4 has an angle with respect to the light incident surface of liquid crystal panel 3 due to the reduction in size of the device. Thus, in the case where liquid crystal panel 3 displays an image having a white window image at the center of a black image, a part of light 1 that constitutes a white image is reflected by absorptive inorganic polarizing plate 2 on the light emission side, passes through liquid crystal panel 3, and is then reflected by reflective inorganic polarizing plate 4 on the light incident side.

More specifically, the light reflected by reflective inorganic polarizing plate 4 is actually not completely linearly polarized light, but includes both S polarized light and P polarized light, one of which accounts for a large part and the other of which accounts for a slight part (in FIG. 3(a), the S polarized light is shown by solid lines and the P polarized light is shown by dotted lines). When light 1 after being reflected by reflective inorganic polarizing plate 4 is the S polarized light, light 1 passes once through white display portion 3a of liquid crystal panel 3 to be a light of P polarized light, is then reflected by absorptive inorganic polarizing plate 2, passes once through black display portion 3b, and returns to reflective inorganic polarizing plate 4. On the other hand, when light 1 after reflected by reflective inorganic polarizing plate 4 is P polarized light, light 1 passes once through white display portion 3a to be a light of S polarized light, is then reflected by absorptive inorganic polarizing plate 2, passes once through white display portion 3a to be light 24 of the P polarized light, and returns to reflective inorganic polarizing plate 4.

In the case of both polarization components, light 24 of P polarized light having reached reflective inorganic polarizing plate 4 is not reflected toward liquid crystal panel 3 but reflected toward the illumination optical system, because reflective inorganic polarizing plate 4 is tilted. This makes clear the boundary between black image 6 and white window image 7 therein (see FIGS. 3(b) and 3(c)). Thus, as shown in FIG. 1(c), a portion corresponding to stray light is not generated at the boundary between the white image and the black image in the projected image.

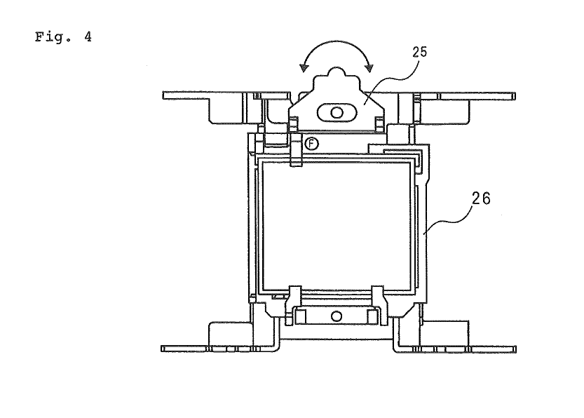

With reflective inorganic polarizing plate 4 placed in the optical path of each color, the direction of the light transmission axis of reflective inorganic polarizing plate 4 has to be adjusted according to the direction of the light transmission axis of absorptive inorganic polarizing plate 2 in order to increase the contrast of an image. Thus, as shown in FIG. 4, support member 26 that supports inorganic polarizing plate 4 on the light incident side or inorganic polarizing plate 2 on the light emission side is desirably provided with mechanism 25 that can rotationally adjust inorganic polarizing plate 4 or 2 around an axis perpendicular to the polarizing plate. In particular, in the blue optical path, reflective inorganic polarizing plate 4 is placed non-parallel with respect to absorptive inorganic polarizing plate 2, and it is not easy to set the direction of the light transmission axis of reflective inorganic polarizing plate 4 according to the light transmission axis of absorptive inorganic polarizing plate 2. Thus, rotational adjustment mechanism 25 is very advantageously added.

As described above, according to this exemplary embodiment, in the projection liquid crystal display device including the illumination optical system that irradiates the liquid crystal panel with light at a various angle with respect to the incident surface thereof to reduce the size of the device, an increase in life of the device and a reduction in cost and also increases in brightness and definition of a projected image can be achieved.

The present invention has been described with reference to the exemplary embodiment, however, the present invention is not limited to the exemplary embodiment. Various modifications that can be understood by those skilled in the art may be made to the configuration and details of the present invention without departing from the scope of the technical idea of the present invention.

### REFERENCE SIGNS LIST

1 light that constitutes image

2, 2(R), 2(G), 2(B) wire grid type absorptive inorganic polarizing plate

3, 3(R), 3(G), 3(B) liquid crystal panel

3a white display portion

3b black display portion

4, 4(R), 4(G), 4(B) reflective inorganic polarizing plate

5 light that forms stray light

6 black image

7 white image

8 portion corresponding to stray light that appears at a boundary between black image and white image

11 lamp unit

12 integrator optical system including polarization conversion element

13 first dichroic mirror

14, 15, 17, 22 condenser lens

18, 19 relay lens

20, 21 total reflection mirror

23 dichroic prism

26 support member

What is claimed is:

1. A projection liquid crystal display device, comprising:
a liquid crystal panel that forms a projected image;
a reflective inorganic polarizing plate placed on a light incident side of said liquid crystal panel; and
an absorptive inorganic polarizing plate placed on a light emission side of said liquid crystal panel,
wherein said reflective inorganic polarizing plate is placed non-parallel with respect to said absorptive inorganic polarizing plate.

2. The projection liquid crystal display device according to claim 1, wherein said reflective inorganic polarizing plate is tilted non-parallel with respect to said absorptive inorganic polarizing plate so that a light that is reflected from said absorptive inorganic polarizing plate to said liquid crystal panel side and that passes through said liquid crystal panel is not again incident on said liquid crystal panel.

3. The projection liquid crystal display device according to claim 2, wherein said absorptive inorganic polarizing plate is placed parallel with respect to said liquid crystal panel.

4. The projection liquid crystal display device according to claim 1, wherein said projection liquid crystal display device comprises a projection liquid crystal display device of a three plate type, and said reflective inorganic polarizing plate and said absorptive inorganic polarizing plate provided in a blue optical path are placed non-parallel with respect to each other.

5. The projection liquid crystal display device according to claim 1, wherein the device is configured so that said liquid crystal panel is irradiated with light at a various angle with respect to a light incident surface thereof.

6. The projection liquid crystal display device according to claim 1, wherein said absorptive inorganic polarizing plate comprises a wire grid type absorptive inorganic polarizing plate.

7. The projection liquid crystal display device according to claim 1, further comprising a mechanism that can rotationally adjust said reflective inorganic polarizing plate or said absorptive inorganic polarizing plate around an axis perpendicular to the polarizing plate.

8. The projection liquid crystal display device according to claim 4, further comprising a mechanism that can rotationally adjust said reflective inorganic polarizing plate or said absorptive inorganic polarizing plate around an axis perpendicular to the polarizing plate.
